(19) United States
(12) Patent Application Publication
(10) Pub. No.: US 2005/0045539 A1
(43) Pub. Date: Mar. 3, 2005

(54) Control device and method for controlling liquid droplets

(75) Inventors: Chih-Sheng Yu, Hsin-Chu City (TW); Yi-Chiuen Hu, Hsin-Chu City (TW); Hsiao-Yu Chou, Jhudong Township (TW); Chien-Jen Chen, Hsin-Chu City (TW); Jing-Tang Yang, Hsin-Chu City (TW); Chia-Hui Chen, Fuxing Shiang (TW)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignees: Precision Instrument Development Center; National Tsing Hua University

(21) Appl. No.: 10/928,052

(22) Filed: Aug. 27, 2004

(30) Foreign Application Priority Data
Aug. 29, 2003 (TW) 092124040

(51) Int. Cl. B01D 1/00

(52) U.S. Cl. 210/143; 210/542; 210/600; 222/52; 422/105; 422/99

(57) ABSTRACT

A control device for controlling a liquid droplet is provided. The control device includes a substrate and a supporting structure made of at least a hydrophobic composite and located on the substrate. A surface energy difference is generated in response to a surface variation of the supporting structure, so as to control a behavior of the liquid droplet.

### FIELD OF THE INVENTION

The present invention is related to a control device, in particular, to a control device for driving the liquid droplet to move, transport, position and mix with another liquid droplet.

### BACKGROUND OF THE INVENTION

Owing to the advantages of the small amounts needed for reacting, the short reaction time and the property of non-attaching on the surface of a hydrophobic layer, liquid droplets have attracted more and more attentions in the microfluidic application. Movable components, such as switch valves and pumps, needed for controlling the continuous flows in the microfluidic channel are not necessary in the liquid-droplet control techniques anymore, which results a convenience in use. Therefore, many efforts are done for studying the liquid-droplet behavior in the recent years and different sorts of liquid-droplet control devices are developed accordingly.

Many methods for controlling the liquid droplets have been already mentioned, for instance, the liquid droplets could be driven by utilizing the heat gradient and the static electric field, by tilting the specimen at a specific angle, and by utilizing the electrowetting technique. The main idea of the foregoing methods is to change the local or the internal property of the liquid droplet, so as to generate an energy variation, which can be transferred into the kinetic energy for driving the liquid droplet.

The working principle-involved in the liquid-droplet controlling is illustrated as follows. When a liquid droplet is located onto a solid surface, a contact angle, which is a specific property of the liquid droplet, would be generated accordingly. Moreover, when the liquid droplet is located onto a hydrophobic surface with a specific structure, a composite surface would be formed between the liquid droplet and the contact surface of the specific structure. The contact angle of the liquid droplet depends on the ratio of the solid-liquid contact area on the composite surface to the total surface area of the liquid droplet. Such a ratio is hereafter called the “structural distribution density”, wherein the contact angle would increase with the decrement of the structural distribution density. In other words, the larger the structural distribution density is, the smaller the contact angle is, and vice versa. Furthermore, the contact angle of the liquid droplet on a composite surface could be quantitatively calculated by a general equation “cos θ₀=f₁ cos θ₁+f₂ cos θ₂”, wherein θ₀ is the contact angle of the liquid droplet on the composite surface, f₁ is a contact ratio of the solid-liquid contact area on the surface of the first material to the total surface area of the liquid droplet, θ₁ is the contact angle of the liquid droplet on the first material, f₂ is a contact ratio of the solid-liquid contact area on the surface of the second material to the total surface area of the liquid droplet and θ₂ is the contact angle of the liquid droplet on the second material.

Based on the equilibrium of surface energy, the conditions of the contact interface between the liquid droplet and the ambient air should comply with the Laplace-Young equation “ΔPₛ=γ(1/r₁+1/r₂)”, wherein ΔPₛ is a difference between the internal pressure and the external pressure of the spherical surface of the liquid droplet, γ is the surface tension of the liquid droplet, and (1/r₁+1/r₂) is the average curvature of the liquid droplet. When the liquid droplet is attached on the interface of two hydrophobic surfaces, a net pressure difference will be generated on the surface of the liquid droplet, because the pressure difference generated between the ambient air and the super-hydrophobic surface, i.e. the surface having a greater hydrophobicity, is larger than that generated between the ambient air and the hydrophobic surface. The net pressure difference will drive the liquid droplet to move toward the surface having a smaller contact angle. That is to say, the liquid droplet will be moved from the super-hydrophobic surface to the hydrophobic surface.

A viscous force F, which can be illustrated in equation “F=γ_{LV}·l·(cos θ_{R}−cos θ_{A})”, between the liquid droplet and the surface of a solid has to be overcome when a static liquid droplet is starting to move, wherein l is a characteristic length of the liquid droplet, γ_{LV} is the surface tension of the liquid droplet, and θ_{R} and θ_{A} are the contact angles thereof while the liquid droplet moves forward and back, respectively. Accordingly, when a force resulted from the net pressure difference is larger than the viscous force, the liquid droplet will start to move spontaneously. Since the liquid droplet will spontaneously move toward the surface, which is less hydrophobic, an additional driving force may be needless to make the liquid droplet move as a result.

Several conventional techniques for driving liquid droplets have been developed. For instance, the electrowetting technique relates to providing a driving force by controlling the electrodes. Through MEMS (Micro-electro-mechanical systems) processing, a driving device having a plurality of electrodes respectively fabricated on an upper and a lower substrate, and a capacitor layer and a hydrophobic layer formed thereon to cover the electrodes is provided. Since the surface of the hydrophobic layer is not easy to be wetted, a liquid droplet having a large contact angle will be formed thereon. The liquid droplet would be kept staying on the surface if no driving force is applied. For driving the liquid droplet to freely move between the upper and the lower substrates, an electric filed is applied to change the property of the liquid droplet through the electrodes, and the contact angle of the liquid droplet is changed as a result. While the contact angle is changed, the surface of the liquid droplet would be varied from a hydrophobic surface to a hydrophilic one. The surface of the substrate is hence more easily wetted thereby. Accordingly, the contact area between the droplet and the surface of the substrate will be increased and become large enough to cover another set of electrodes, and the liquid droplet will be driven to move by switching the electrodes in turns.

The electrowetting technique realizes the moving and the positioning for liquid droplets through the surface property variation by switching the electrodes. However, in order to fabricate a plurality of micro electrodes on the substrate for controlling the moving path of the liquid droplet, a complicated micro processing is needed in this technique, which restricts the application of such a driving device.

Another conventional technical scheme for driving the liquid droplet to move is realized by tilting the substrate. By putting a liquid droplet on a hydrophobic substrate and then tilting the substrate at a specific angle, the liquid droplet will be drawn by the gravity thereof and start to move. An additional device is needless for driving the liquid droplet. However, a precise positioning is difficult to be realized through this scheme.

There is still another conventional technique involved in driving the liquid droplet. Please refer to FIG. 1, which illustrates the driving device according to the prior art. The driving device 1′ includes a thin polydimethylsiloxane (PDMS) membrane 12′ suspended on the top of a rough PDMS substrate 11′, and a plurality of air paths 13′ are formed therebetween. The surface roughness of the driving device 1′ is switched by the PDMS membrane 12′, which is actuated through a pneumatic method. While the air is pumped out through the plurality of air paths 13′, the PDMS membrane 12′ would be tightly sucked and attached on the PDMS substrate 11′. It is found that the surface wettability is dynamically switched from the hydrophobic state to super-hydrophobic state thereby. This technology enables a microscale transport mechanism for the liquid droplet by surface tension without using the thermal effect or the electrical potential.

Additionally, a conventional driving method related to generating a static electric field to drive the liquid droplet is disclosed in the U.S. Pat. No. 5,486,337. It is realized by controlling a plurality of electrodes formed on a substrate.

The surface of the hydrophobic layer is not easy to be wetted by the liquid. The hydrophobicity is one intrinsic property of the material, and a combination of various materials with different hydrophobicities is able to make a net pressure difference for driving the liquid droplet accordingly. Furthermore, surfaces having different structural distribution densities can be formed through a micro processing. The liquid droplet is able to be driven by the various surface structures. In order to realize the purpose of minimizing the driving force, it is necessary to enhance the surface property of the hydrophobic layer, and a driving system fabricated by combining the hydrophobic layer with the micro or nano surface structures is possible. Additionally, since the surface of the moving path of the liquid droplet is always hydrophobic and has a self-cleaning effect, the dust is not easy to be attached on such a driving system. Moreover, the driving system has a high biological capacity and a simplified structure.

Based on the relevant developed conventional technologies, the surface property of the solid can be enhanced by increasing the surface roughness thereof. In other words, a greater surface roughness makes the hydrophilic surface more hydrophilic and also makes the hydrophobic surface more hydrophobic. Moreover, the surface roughness of the substrate could be increased for changing the surface energy thereof through the laser processing.

Since the contact angle of a liquid droplet on a solid surface can be increased through increasing the surface roughness, there are more and more efforts being done for enhancing the surface properties thereof. One conventional method is to form a rough surface on the surface of a fixed substrate. This may make a hydrophobic surface more hydrophobic, and make a hydrophilic surface more hydrophilic. Moreover, the surface energy thereon could be further increased by the increment of the surface roughness, which is resulted from fabricating the surface via a laser.

Another conventional method for increasing the contact angle of the liquid droplet on a solid surface is related to the Lotus effect. The surface roughness is increased by forming a plurality of nano-scaled structures on the micro-scaled surface, and covering a hydrophobic layer thereon. The hydrophobic layer would make the liquid droplet to have a larger contact angle. Furthermore, due to the composite structure of nano-scaled structures and the micro-scaled surface, the liquid droplet will be difficult to be attached onto the surface of the substrate. Accordingly, the impurity on the surface is taken away therefrom when the liquid droplet is moving. This technique realizes a function of self-cleaning.

A high surface area substrate for the biomedical detection is provided in U.S. Patent Pub No. 2003/0148401 A1. Please refer to FIG. 2. The substrate 201′ has a plurality of reaction wells 202′ and a hydrophobic layer 203′ on its surface. Each of the reaction wells 202′ is a separated microarray and the fluids introduced therein for a specific reaction could be different or the same. Within each reaction well 202′, there are a plurality of detection areas 2022′ defined by plural hydrophobic boundaries 2021′. Furthermore, a plurality of microstructures 20222′ are provided within each of the hydrophobic boundaries 2021′ for preventing the agent contamination.

Additionally, a conventional technique for driving the liquid droplets to mix with each other by switching the electrodes is developed. The droplet mixing is able to be enhanced by pulling the droplet to move for a distance to contact with another droplet. While the two droplets contact with other, they will be well mixed through the diffusion therebetween and the movement driven by the electrodes.

Based on the above, it is understood that an additional driving force is necessary for the liquid droplet moving, positioning and mixing. However, such an additional driving force always changes the properties of the liquid droplet. For example, while a field of thermal gradient is used, the liquid having the droplets will be evaporated due to the heat generation of the applied heat source. While the liquid droplets are driven by an applied field, the contents in the liquid droplet would be easily polarized. Moreover, if the field is applied for the biomedical detection, the properties of the solution and the biological molecules would be further influenced, which may result in an erroneous detection. While the liquid droplets are driven through a tilt method, it is difficult to precisely position the liquid droplet because the velocity thereof is hard to control. Additionally, the microfluidic mixing is also an important and thorny problem in the foregoing techniques according to the prior art.

Therefore, it is an issue of great urgency to provide a control device, which can quickly and precisely position, transport and mix the liquid droplets. Besides, the fabrication for the control device has to be simplified for reducing the cost for production.

### SUMMARY OF THE INVENTION

In accordance with an aspect of the present invention, a control device for controlling a liquid droplet is provided. The control device includes a substrate and a structure made of at least a hydrophobic composite and located on the substrate.

Preferably, a surface energy difference is generated in response to a surface variation of the structure, so as to control a behavior of the liquid droplet.

Preferably, the behavior of the liquid droplet is one selected from a group consisting of movement, acceleration, deceleration, position, mix and a combination thereof.

Preferably, the substrate is one selected from a glass, a silicon chip and a plastic.

Preferably, the structure has a micro-scaled size.

Preferably, the structure has a nano-scaled size.

Preferably, the hydrophobic composite further includes at least two materials respectively having different properties.

Preferably, one of the at least two materials is a hydrophobic layer made of one selected from a group consisting of Teflon, PPFC and parylene.

Preferably, one of the at least two materials is a hydrophobic air layer.

Preferably, the surface variation is resulted from a scraggy surface of the structure for reinforcing a hydrophobicity of the structure.

Preferably, the scraggy surface is formed by one of a physical process and a chemical process.

Preferably, the scraggy surface is formed by one selected from a group consisting of a hot pressing method, a laser method, a particle impaction method and an ion implantation method.

Preferably, the liquid droplet is further driven by the surface energy difference to have a speed for movement.

Preferably, the liquid droplet further has a moving path, which is determined by a surface property of the hydrophobic composite.

Preferably, the liquid droplet moves from a first area with a first surface density of the hydrophobic composite to a second area with a second surface density thereof.

Preferably, the first surface density is smaller than the second surface density.

Preferably, the liquid droplet further stops in the first area.

Preferably, the hydrophobic composite further has a third area with a largest surface density, and the third area is a flat surface.

In accordance with another aspect of the invention, a control method for controlling a behavior of a liquid droplet is provided. The control method includes a step of employing the control device as described above.

The foregoing and other features and advantages of the present invention will be more clearly understood through the following descriptions with reference to the drawings, wherein:

### BRIEF DESCRIPTION OF THE DRAWINGS

FIG. 1 is a diagram illustrating the driving device according to the prior art;

FIG. 2 is a diagram illustrating a high surface area substrate for the biomedical detection according to the prior art;

FIG. 3 is a diagram illustrating the control device according to a preferred embodiment of the present invention;

FIGS. 4(a) to 4(c) are diagrams illustrating the droplet mixing in the control device according to the preferred embodiment of the present invention;

FIGS. 5(a) and 5(b) respectively illustrating the moving and the positioning of the liquid droplet in the control device according to the preferred embodiment of the present invention;

FIG. 6 is a diagram illustrating the supporting structure in the control device of the preferred embodiment according to the present invention; and

FIG. 7 is a diagram illustrating the control device of a second preferred embodiment according to the present invention.

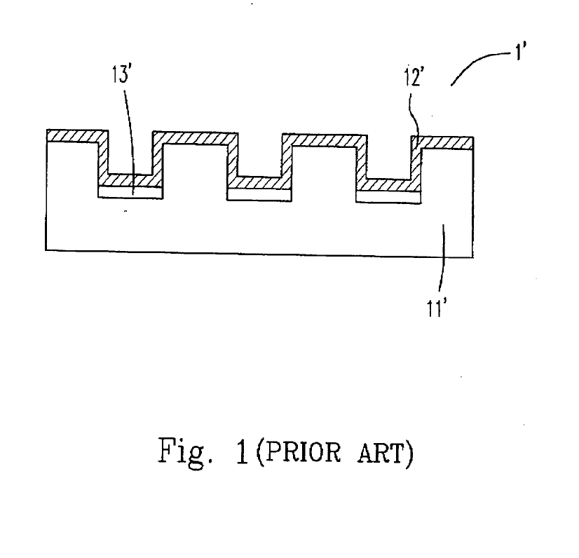

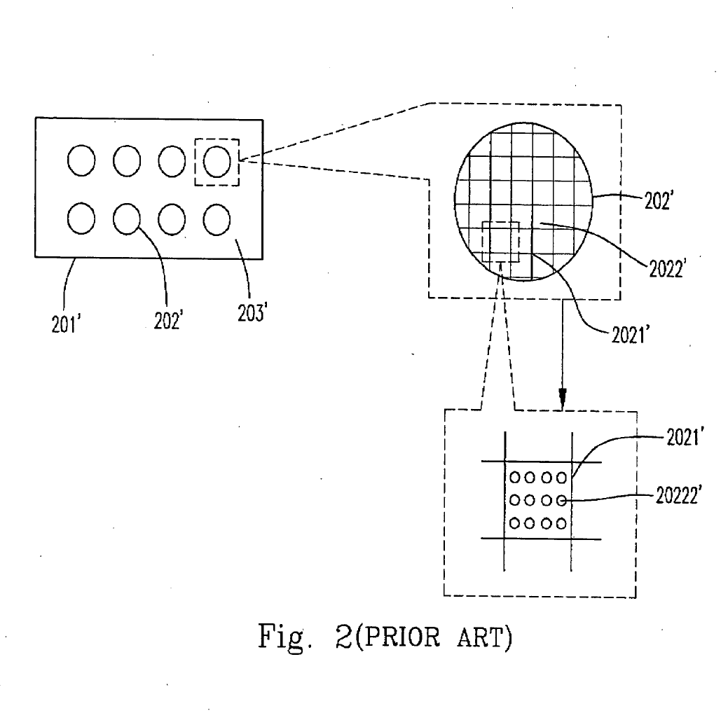

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The present invention relates to generating various surface energies for driving the liquid droplet through a variation of the surface structural density of the hydrophobic layer. The liquid droplet is hence driven to be transported, positioned and mixed.

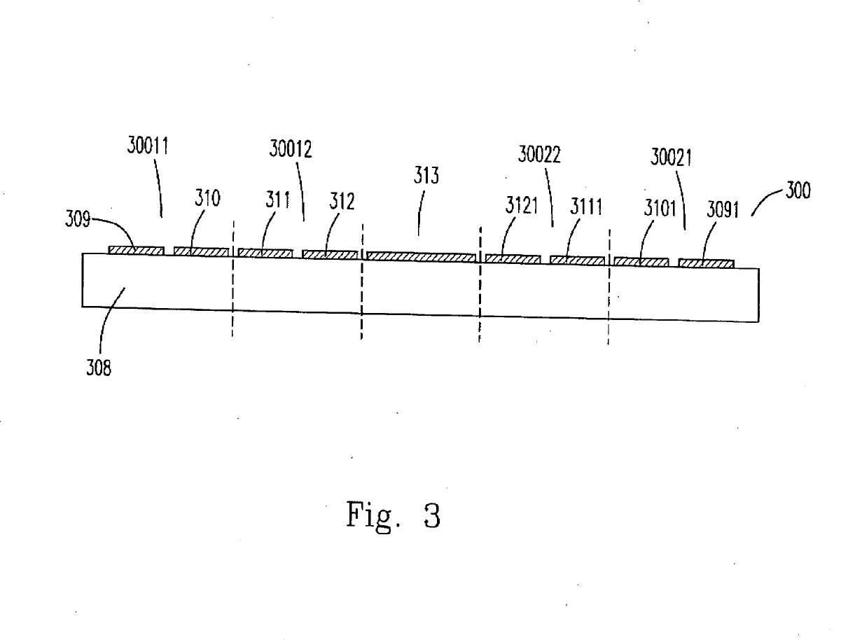

Please refer to FIG. 3, which illustrates the control device of a preferred embodiment according to the present invention. The control device 300 includes a first droplet-moving zone 30011, a first droplet-positioning zone 30012, a second droplet-moving zone 30021, a second droplet-positioning zone 30022 and a droplet-mixing zone 313. Moreover, the first droplet-moving zone 30011 has a first supporting structure 309 and a second supporting structure 310, which are made of a hydrophobic layer. The first droplet-positioning zone 30012 has a third supporting structure 311 and a fourth supporting structure 312, which are also made of a hydrophobic layer. Similarly, the second droplet-moving zone 30021 and the second droplet-positioning zone 30022 respectively have a fifth supporting structure 3091 and a sixth supporting structure 3101, and a seventh supporting structure 3111 and a eighth supporting structure 3121, which are all made of a hydrophobic layer. All of the above supporting structures are formed on a substrate 308.

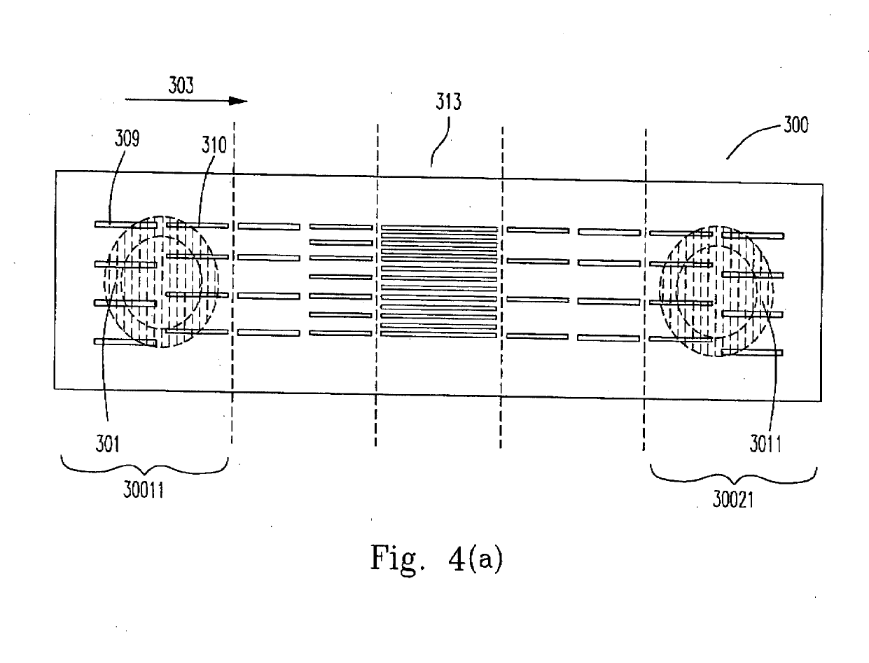

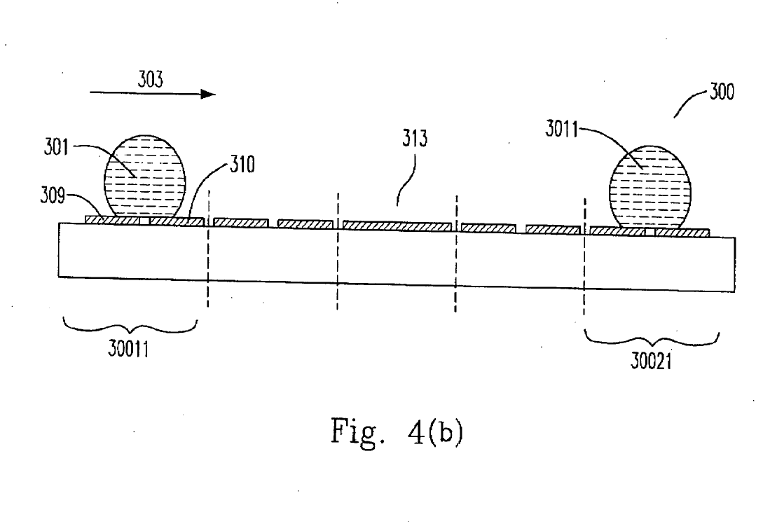

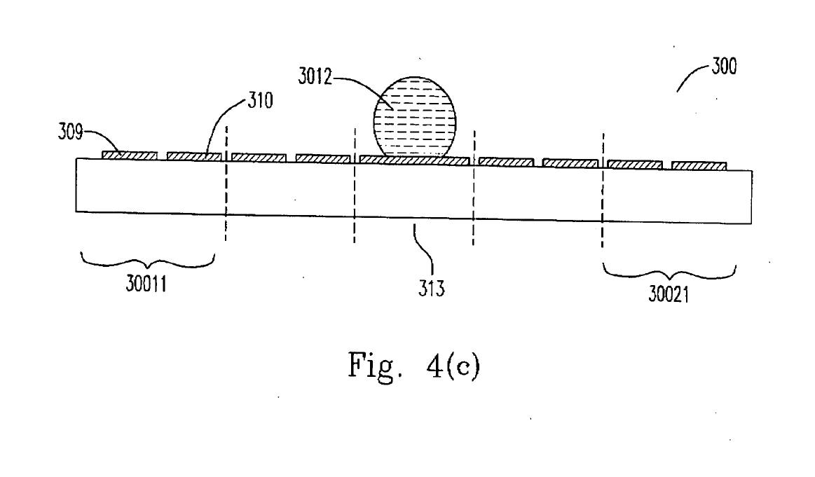

Please refer to FIGS. 4(a) to 4(c) illustrating the droplet mixing in the control device according to FIG. 3, wherein FIG. 4(a) is a top-view diagram, and FIGS. 4(b) and 4(c) are side-view diagrams. Referring to FIGS. 4(a) and 4(b), when a first liquid droplet 301 is put on the first droplet-moving zone 30011 of the control device 300, the first liquid droplet 301 will spontaneously move along the direction 303 due to the variation of the structural density on the surface of the control device 300. The various structural density thereon is resulted from a designed composed ratio of the first supporting structure 309 and the second supporting structure 310. A similar situation also would be also performed when a second liquid droplet 3011 is put on the second droplet-moving zone 30021. The first liquid droplet 301 and the second liquid droplet 3011 are hence driven and gradually move to the mixing zone 313, and are mixed with each other thereon. A third liquid droplet 3012 is formed on the mixing zone 313 as a result, which is shown in FIG. 4(c).

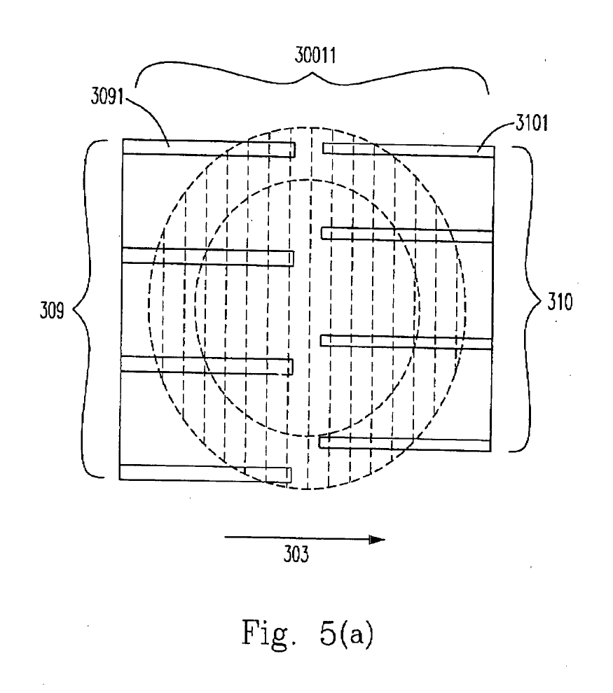

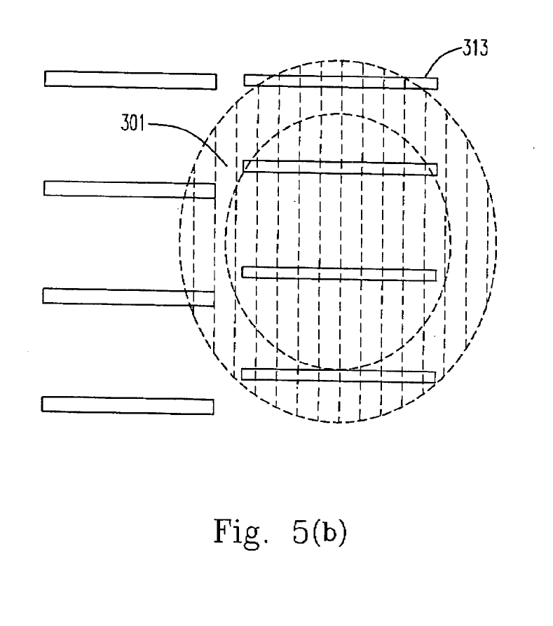

Please refer to FIGS. 5(a) and 5(b), which respectively illustrate the moving and the positioning of the liquid droplet in a greater detailed.

As shown in FIG. 5(a), the second supporting structure 310 has a plurality of protrusions 3101 which are arranged more closed than that of the first supporting structure 309. That is to say, the structural density of the first supporting structure 309 is smaller than that of the second supporting structure 310, because the first supporting structure 309 has a plurality of protrusions 3901 arranged in a looser arrangement. Therefore, as shown in FIGS. 5(a) and 5(b), when the first liquid droplet 301 is generated and then put on the first droplet-moving zone 30011, it will be moved along the direction 303, i.e. the first liquid droplet 301 will be moved from the first supporting structure 309 to the second supporting structure 310. Moreover, the first liquid droplet 301 is moved forward and further positioned on the mixing zone 313 due to the mixing zone 313 has the largest structural density, as shown in FIG. 5(b).

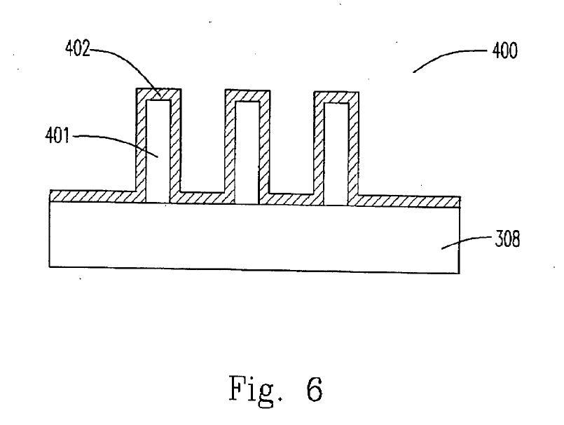

Please refer to FIG. 6, which illustrates the supporting structure in the control device of the preferred embodiment according to the present invention. The supporting structure 400 includes a substrate 308, a plurality of protrusions 401 with a micro-scaled size thereon and a hydrophobic layer 402 with a nano-scaled size covering the substrate 308 and the plurality of protrusions 401. Additionally, the supporting structure 400 is made by a hot pressing method, a laser method, a particle impaction method or an ion implantation method.

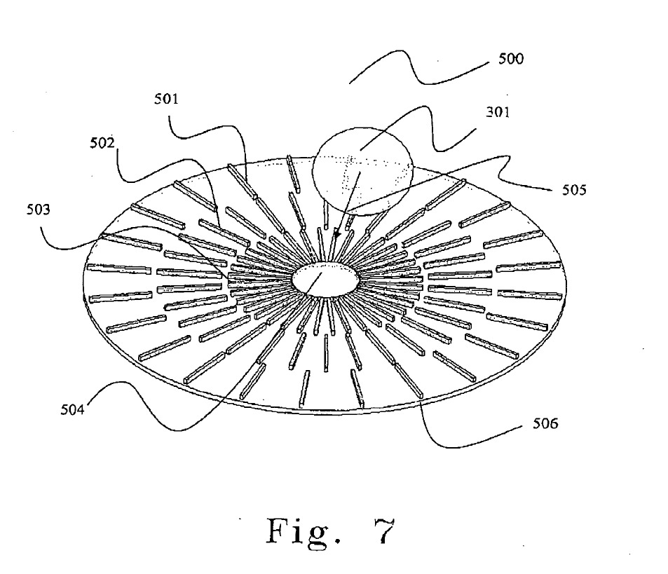

Please refer to FIG. 7, which illustrates the control device of a second preferred embodiment according to the present invention. The control device 500 has a round shaped substrate 506, a first supporting structure 501, a second supporting structure 502, a third supporting structure 503 and a fourth supporting structure 504. When the liquid droplet 301 is put thereon, it is able to be precisely guided toward along the direction 505 and finally positioned on the fourth supporting structure 504, which has the largest structural density.

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A control device for controlling a liquid droplet, comprising:
a substrate; and
a structure made of at least a hydrophobic composite and located on said substrate;
wherein a surface energy difference is generated in response to a surface variation of said structure, so as to control a behavior of said liquid droplet.

2. The control device according to claim 1, wherein said behavior of said liquid droplet is one selected from a group consisting of movement, acceleration, deceleration, position, mix and a combination thereof.

3. The control device according to claim 1, wherein said substrate is one selected from a glass, a silicon chip and a plastic.

4. The control device according to claim 1, wherein said structure has a micro-scaled size.

5. The control device according to claim 1, wherein said structure has a nano-scaled size.

6. The control device according to claim 1, wherein said hydrophobic composite further comprises at least two materials respectively having different properties.

7. The control device according to claim 6, wherein one of said at least two materials is a hydrophobic layer made of one selected from a group consisting of Teflon, PPFC and parylene.

8. The control device according to claim 6, wherein one of said at least two materials is a hydrophobic air layer.

9. The control device according to claim 1, wherein said surface variation is resulted from a scraggy surface of said structure for reinforcing a hydrophobicity of said structure.

10. The control device according to claim 9, wherein said scraggy surface is formed by one of a physical process and a chemical process.

11. The control device according to claim 10, wherein said scraggy surface is formed by one selected from a group consisting of a hot pressing method, a laser method, a particle impaction method and an ion implantation method.

12. The control device according to claim 1, wherein said liquid droplet is further driven by said surface energy difference to have a speed for movement.

13. The control device according to claim 1, wherein said liquid droplet further has a moving path, which is determined by a surface property of said hydrophobic composite.

14. The control device according to claim 1, wherein said liquid droplet moves from a first area with a first surface density of said hydrophobic composite to a second area with a second surface density thereof.

15. The control device according to claim 14, wherein said first surface density is smaller than said second surface density.

16. The control device according to claim 15, wherein said liquid droplet further stops in said first area.

17. The control device according to claim 14, wherein said hydrophobic composite further has a third area with a largest surface density, and said third area is a flat surface.

18. A control method for controlling a behavior of a liquid droplet, comprising a step of employing said control device as claimed in claim 1.
